(19) United States
(12) Patent Application Publication
(10) Pub. No.: US 2011/0257059 A1
(43) Pub. Date: Oct. 20, 2011

(54) Process for Making a Detergent

(76) Inventors: Nigel Patrick Somerville Roberts, Newcastle upon Tyne (GB); Hossam Hassan Tantawy, Northumberland (GB); Eric San Jose Robles, Newcastle upon Tyne (GB)

(21) Appl. No.: 13/086,655

(22) Filed: Apr. 14, 2011

(30) Foreign Application Priority Data
Apr. 19, 2010 (EP) 10160350.4

(51) Int. Cl. C11D 17/00; B01D 1/18

(52) U.S. Cl. 510/276; 159/48.1

(57) ABSTRACT

A process for the production of a spray-dried detergent powder including a hexagonal-phase-in-water-forming surfactant the process including the steps of: (i) spraying into a spray-drying tower a detergent slurry preferably free of a hexagonal-phase-in-water-forming surfactant; and (ii) simultaneously spraying a paste having a hexagonal-phase-in-water-forming surfactant, whereby droplets of the slurry encounter droplets or powder of the hexagonal-phase-in-water-forming surfactant paste so as to form composite granules.

### FIELD OF THE INVENTION

The present invention relates to a process for making a detergent composition. In particular it relates to a spray-drying process, the process comprises the step of co-spraying a slurry and a paste.

### BACKGROUND OF THE INVENTION

The handling of surfactants during a manufacturing process for making a detergent can be challenging due to the formation of different surfactant phases that alter the physical properties of surfactants, in particular rheology and make their handling and processing, including spray-drying and agglomeration, difficult. Surfactants can also interact with other detergent ingredients and impair on the flowability and solubility of the finished detergent. The interaction of surfactants with other detergent ingredients can also impair on the availability during the cleaning process of the surfactant and/or other detergent ingredients, negatively influencing on the cleaning performance.

An objective of the present invention is to provide a flexible, versatile and simple process for the production of detergents. Another objective of the present invention is to provide a detergent composition with improved physical properties that provides improved cleaning.

### SUMMARY OF THE INVENTION

According to a first aspect of the invention, there is provided a process for the production of a spray-dried detergent powder. The detergent powder comprises a hexagonal-phase-in-water-forming surfactant.

By “hexagonal-phase-in-water-forming surfactant” is herein understood a surfactant that would form hexagonal phase when mixed with water in an amount of from about 20% to about 70% of surfactant by weight of the mixture in a range temperature of from about 20° C. to about 95° C. The hexagonal phase can be detected using a polarized light microscope (see for example, The Aqueous Phase Behavior of Surfactant, R. Laughlin, Academic Press 1994, pp. 538-542) and/or x-ray diffraction (XRD) and/or small angle x-ray scattering (SAXS) (see for example, A. Svensson, et al, J. Phys. Chem. B, 106, 1013 (2002); K. Fontell, Colloid Poly. Sci. 268, 264 (1990); F. Muller, et al, Colloids Surf. A, 358, (2010), 50-56.). The diffraction pattern of the hexagonal liquid crystalline lattices exhibits Bragg peaks with the relative d-value ratios of 1:1/√3:1/√4:1/√7:1/√9 for the diffraction planes or Miller's indices {hkl} of {1 0}, {1 1}, {2 0}, {2 1}, {3 0}, respectively.

Surfactants being in the hexagonal phase usually present a challenging rheology, they tend to be highly viscous, this makes their handling in plants very difficult, costly and in some occasions impossible to handle. This is especially detrimental when spray-drying or agglomeration is involved. The surfactant can become so viscous that it could block the spray nozzles and it can be impossible to atomize.

The process of the invention comprises the steps of
(i) spraying into a spray-drying tower a detergent slurry preferably free of a hexagonal-phase-in-water-forming surfactant; and
(ii) simultaneously spraying a paste comprising a hexagonal-phase-in-water-forming surfactant.

By “free of a hexagonal-phase-in-water-forming surfactant” is meant that the slurry contains less than 5%, preferably less than 2% and more preferably less than 1% of a hexagonal-phase-in-water-forming surfactant by weight of the slurry.

Steps (i) and (ii) jointly are herein sometimes referred to as “co-spray”.

Preferred hexagonal-phase-in-water-forming surfactants include sulphate detersive surfactants. Especially preferred for use herein are sulphate detersive surfactants, in particular alkyl ethoxylated sulphates and more in particular a C₈₋₁₈ alkyl ethoxylated sulphate having an average degree of ethoxylation of from 0.5 to 10, preferably from 0.5 to 7, more preferably from 0.5 to 5 and most preferably from 0.5 to 3.

In a preferred embodiment the paste comprises from about 55% to about 95%, more preferably from about 65% to about 75% of water by weight thereof. Preferably the paste comprises an inorganic salt, preferred inorganic salts for use herein include sulphate and carbonate. Pastes comprising these inorganic salts seem to be very good in avoiding formation of the hexagonal phase and have very favorable rheology in terms of handling. Optionally the paste comprises an organic salt, preferred organic salts for use herein include citrates and succinates, especially preferred succinate for use herein are the salts of ethylene:di:amine-N,N′-di:succinic acid. The organic salts can contribute to improve physical characteristics of the composite granule (crisper granules).

In a preferred embodiment the paste is sprayed at a temperature of from about 35° C. to about 80° C. This avoids the formation of unwanted inorganic hydrates such as sodium sulphate decahydrate which could make the paste too viscous. Avoiding very high temperatures minimizes the chance of the hexagonal-phase-in-water-forming surfactant undergoing unwanted thermal degradation. The location of the spraying of the paste can be chosen to reduce the residence time in the tower and hence limit the temperature that the hexagonal-phase in water forming surfactant experiences. Another possibility is to include a very low level of a cationic surfactant in the paste. This has been found to increase the drying rate of the paste—presumably via a mechanism of disrupting any liquid crystal phases and allowing easier escape of water—and hence increasing the evaporative cooling effect.

The slurry used in the process of the invention comprises normal base powder detergent ingredients, including surfactants, builders and fillers. Preferably the slurry is free of hexagonal-phase-in-water-forming surfactant. It is also preferred that the slurry comprises surfactants other than hexagonal-phase-in-water-forming surfactant. In preferred embodiments the slurry comprises a sulphonate detersive surfactant.

According to a second aspect of the invention, there is provided a detergent composition obtainable and preferably obtained according to the process of the invention. The detergent presents good flowability and good dissolution profile that can be translated into improved cleaning performance.

According to the last aspect of the invention, there is provided a spray-dried granular detergent composition including composite granules comprising:

(i) a core granule comprising one or more anionic (preferably a sulphonate detersive surfactant) and/or nonionic detergent-active compounds and preferably free of a hexagonal-phase-in-water-forming surfactant, and
(ii) an outer layer, in the form of a coating or of smaller particles, comprising a hexagonal-phase-in-water-forming surfactant.

### DETAILED DESCRIPTION OF THE INVENTION

The present invention envisages a process for making a detergent composition comprising the step of co-spraying a detergent slurry and a paste comprising a hexagonal-phase-in-water-forming surfactant. The paste has a very favorable rheology that improves handleability of the surfactants and allows for process simplification. The invention also envisages a spray-dried granular detergent composition and a detergent composition obtainable, preferably obtained, according to the process of the invention. The composition presents improved solubility and can provide cleaning benefits.

The key step in the process of the invention is the co-spray (i.e., simultaneously spraying) of a detergent slurry, preferably free of a hexagonal-phase-in-water-forming surfactant and a paste comprising a hexagonal-phase-in-water-forming surfactant. The separation of the detergent slurry and the hexagonal-phase-in-water-forming surfactant avoids the formation of unwanted surfactant phases that are rheologically unfavorable. This facilitates the process of making the detergent and can contribute to improve cleaning performance of the detergent.

### Co-Spray

Generally the detergent slurry is sprayed downwardly from one or more nozzles situated in the upper part of the tower, while hot air is blown upwardly from a ring main situated near the base of the tower. As the slurry droplets descend they rapidly lose moisture to form granules, which are initially wet and sticky but become progressively less so as they fall, until at the collection point at the base of the tower they are relatively dry. The nozzles from which the slurry is sprayed may be of any suitable type, for example, swirl and tip nozzles.

Simultaneously, a paste comprising a hexagonal-phase-in-water-forming surfactant is sprayed separately into the tower from a separate nozzle or set of nozzles Like those used for the slurry, these may be of any suitable type, for example, swirl and tip nozzles.

The relative positions of the two nozzles or sets of nozzles appears not to be critical, nor does the direction in which the paste is sprayed in relation either to the direction of spray-in of the slurry (which is generally, but not necessarily, downward) or to the direction of the hot air flow, which is normally upward. Whatever the arrangement chosen, the aim is to maximise the probability of collisions between the droplets of paste and the slurry droplets or base powder granules to form agglomerated composite particles. It should also be remembered that the wetter the slurry droplets or base powder granules when collisions occur, the greater the chance of the formation of composite granules.

A suitable arrangement is when the slurry is sprayed downwardly from a position near the top of the tower and the paste is sprayed upwardly from a level lower than that from which the slurry is sprayed. In this arrangement, the distance between the levels at which the two components enter the tower can apparently vary quite widely. Distances from 1.0 to 4.5 meters have been found to give satisfactory powders, although the granules making up these powders differ depending on the separation, as discussed below. Alternatively, the distance between the hot air inlet and the spray-in level for the paste may be considered: distances of from 2.5 to 5.0 meters have been found to be satisfactory.

In principle, many other arrangements could be adopted. For example, the two components could both be sprayed in the same direction—preferably downwards—from the same level; or the paste spray-in position might be higher than that of the slurry spray-in, with downward spraying of the paste. The essential feature of the invention is that mixing of the two components does not occur until after each has been separately atomised.

Advantageously the temperature of the sprayed-in paste is not higher than ambient (say 30° C.): this slows down the rate of drying of the paste. A low atomising pressure is also advantageous in giving larger droplets. Both these measures increase the probability of collisions leading to the formation of composite granules.

Detergent powders prepared by the process of the invention are characterised by the presence of composite granules which are readily recognisable, and quite different from the particles produced from processes in which the hexagonal-phase-in-water-forming-surfactant is incorporated via the slurry, or from processes in which the hexagonal-phase-in-water-forming-surfactant is postdosed as a solid, such as an agglomerate. The composite granules are composed of a core of base powder derived from the slurry, and an outer layer, generally in the form of a partial or complete coating or of discrete smaller particles, of hexagonal-phase-in-water-forming-surfactant. Thus detergent powders containing such composite granules constitute the second aspect of the present invention.

The structure and constitution of the composite granules will vary according to the relative positions of the slurry spray-in, the paste spray-in and the hot air inlet; the directions of the sprays in relation to each other and to the direction in which hot air is travelling; the type of atomiser used and the atomising pressure; and the inlet temperature of the paste. Under conditions in which the paste dries slowly and contacts the base powder particles while still liquid, a preponderance of coated particles is obtained. For example the proportion of composite granules can be increased by moving the paste spray-in nozzle. The homogeneity of the product is also increased thereby. A homogeneous product is somewhat preferable to a heterogeneous product, but both are acceptable and within the scope of the present invention. Under conditions in which the paste dries fast, or dries before the droplets contact the base powder particles, a relatively high proportion of separate base powder granules and hexagonal-phase-in-water-forming-surfactant particles, the latter generally in the form of spheres, will be obtained. There could, however, also be some agglomerates present in which relatively small particles of hexagonal-phase-in-water-forming-surfactant are clustered around larger base powder granules. These various structures are readily detectable by microscopy.

A typical composite particle may contain from 1 to 20%, preferably from 2 to 10% by weight of hexagonal-phase-in-water-forming-surfactant.

The slurry used in the process of the invention to form a base powder will generally contain any heat-insensitive ingredients to be incorporated in the product.

### Detergent Slurry

The slurry for use in the process of the present invention is usually an aqueous slurry and comprises a detersive surfactant, preferably selected from the group consisting of anionic, non-ionic, cationic surfactants and mixtures thereof. Preferably the slurry is free of hexagonal-phase-in-water-forming surfactant.

The aqueous detergent slurry typically comprises other detergent ingredients, such as alkalinity source, polymer, builder, filler salts and mixtures thereof.

It may also be especially preferred for the aqueous detergent slurry to comprise low levels, or even be free, of builder. Preferably, the aqueous detergent slurry comprises from 0 wt % to 10 wt %, or to 9 wt %, or to 8 wt %, or to 7 wt %, or to 6 wt %, or to 5 wt %, or to 4 wt %, or to 3 wt %, or to 2 wt %, or to 1 wt % zeolite builder. Preferably, the aqueous detergent slurry is essentially free of zeolite builder.

Preferably, the aqueous detergent slurry comprises from 0 wt % to 10 wt %, or to 9 wt %, or to 8 wt %, or to 7 wt %, or to 6 wt %, or to 5 wt %, or to 4 wt %, or to 3 wt %, or to 2 wt %, or to 1 wt % phosphate builder. Preferably, the aqueous detergent slurry is essentially free of phosphate builder.

Preferably the aqueous detergent slurry is alkaline. Preferably, the aqueous detergent slurry has a pH of greater than 7.0, preferably greater than 7.7, or greater than 8.1, or even greater than 8.5, or greater than 9.0, or greater than 9.5, or greater than 10.0, or even greater than 10.5, and preferably to 14, or to 13, or to 12.

Preferred surfactants for use in the slurry include sulphonate detersive surfactants, in particular alkyl benzene sulphonate, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable surfactant is alkyl benzene sulphonate that is obtained by DETAL catalyzed process, although other synthesis routes, such as HF, may also be suitable.

The surfactants may be linear or branched, substituted or un-substituted. The surfactants may be a mid-chain branched detersive surfactant, preferably the slurry comprises a surfactant is a mid-chain branched alkyl benzene sulphonate, most preferably a mid-chain branched alkyl sulphate. Preferably, the mid-chain branches are C₁₋₄ alkyl groups, preferably methyl and/or ethyl groups.

Suitable non-ionic detersive surfactants are selected from the group consisting of: C8-C18 alkyl ethoxylates, such as, NEODOL® non-ionic surfactants from Shell; C6-C12 alkyl phenol alkoxylates wherein preferably the alkoxylate units are ethyleneoxy units, propyleneoxy units or a mixture thereof; C12-C18 alcohol and C6-C12 alkyl phenol condensates with ethylene oxide/propylene oxide block polymers such as Pluronic® from BASF; C14-C22 mid-chain branched alcohols; C14-C22 mid-chain branched alkyl alkoxylates, preferably having an average degree of alkoxylation of from 1 to 30; alkylpolysaccharides, preferably alkylpolyglycosides; polyhydroxy fatty acid amides; ether capped poly(oxyalkylated) alcohol surfactants; and mixtures thereof. Preferred non-ionic detersive surfactants are alkyl polyglucoside and/or an alkyl alkoxylated alcohol.

Preferred non-ionic detersive surfactants include alkyl alkoxylated alcohols, preferably C8-18 alkyl alkoxylated alcohol, preferably a C8-18 alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C8-18 alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable cationic detersive surfactants include alkyl pyridinium compounds, alkyl quaternary ammonium compounds, alkyl quaternary phosphonium compounds, alkyl ternary sulphonium compounds, and mixtures thereof.

Preferred cationic detersive surfactants are quaternary ammonium compounds having the general formula:

(R)(R1)(R2)(R3)N+X−

wherein, R is a linear or branched, substituted or unsubstituted C₆₋₁₈ alkyl or alkenyl moiety, R1 and R2 are independently selected from methyl or ethyl moieties, R3 is a hydroxyl, hydroxymethyl or a hydroxyethyl moiety, X is an anion which provides charge neutrality, preferred anions include: halides, preferably chloride; sulphate; and sulphonate. Preferred cationic detersive surfactants are mono-C₆₋₁₈ alkyl mono-hydroxyethyl di-methyl quaternary ammonium chlorides. Highly preferred cationic detersive surfactants are mono-C₈₋₁₀ alkyl mono-hydroxyethyl di-methyl quaternary ammonium chloride, mono-C10-12 alkyl mono-hydroxyethyl di-methyl quaternary ammonium chloride and mono-C10 alkyl mono-hydroxyethyl di-methyl quaternary ammonium chloride.

### Paste Comprising a Hexagonal-Phase-in-Water-Forming Surfactant

Preferred surfactants for use herein include sulphate detersive surfactants, more preferably an alkyl sulphate and especially a C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 7, more preferably from 0.5 to 5 and most preferably from 0.5 to 3.

Preferably the surfactant paste comprises an inorganic salt, more preferably a mixture of sulfate and carbonate. It is also preferred that the surfactant paste comprises a cationic surfactant. Cationic surfactants are defined herein before.

### Detergent Composition

Preferably the detergent composition obtained or obtainable according to the process of the invention comprises (by weight of the composition):

(a) from 0 wt % to 10 wt % zeolite builder;
(b) from 0 wt % to 10 wt % phosphate builder; and
(c) optionally from 0 wt % to 15 wt % silicate salt.

### Zeolite Builder

Suitable zeolite builder includes include zeolite A, zeolite P and zeolite MAP. Especially suitable is zeolite 4A.

### Phosphate Builder

A typical phosphate builder is sodium tri-polyphosphate.

### Silicate Salt

A suitable silicate salt is sodium silicate, preferably 1.6R and/or 2.0R sodium silicate.

### Other Detergent Ingredients

The composition typically comprises other detergent ingredients. Suitable detergent ingredients include: transition metal catalysts; imine bleach boosters; enzymes such as amylases, carbohydrases, cellulases, laccases, lipases, bleaching enzymes such as oxidases and peroxidases, proteases, pectate lyases and mannanases; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; suds suppressing systems such as silicone based suds suppressors and/or fatty acid based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters and/or terephthalate polymers, polyethylene glycol including polyethylene glycol substituted with vinyl alcohol and/or vinyl acetate pendant groups; perfumes such as perfume microcapsules, polymer assisted perfume delivery systems including Schiff base perfume/polymer complexes, starch encapsulated perfume accords; soap rings; aesthetic particles including coloured noodles and/or needles; dyes; fillers such as sodium sulphate, although it may be preferred for the composition to be substantially free of fillers; carbonate salt including sodium carbonate and/or sodium bicarbonate; silicate salt such as sodium silicate, including 1.6R and 2.0R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose, and hydrophobically modified cellulose; carboxylic acid and/or salts thereof, including citric acid and/or sodium citrate; and any combination thereof.

### EXAMPLES

### Example 1

### A Spray-Dried Laundry Detergent Powder and Process of Making it

### Aqueous Alkaline Slurry Composition.

| Component | Aqueous slurry (parts) |
|---|---|
| Sodium Silicate | 8.5 |
| Acrylate/maleate copolymer | 3.2 |
| Hydroxyethane di(methylene phosphonic acid) | 0.6 |
| Sodium carbonate | 7.8 |
| Sodium sulphate | 42.9 |
| Water | 19.7 |
| Miscellaneous, such as magnesium sulphate, | 1.7 |
| and one or more stabilizers | |
| Aqueous alkaline slurry parts | 85.4 |

### Preparation of a Spray-Dried Laundry Detergent Powder.

An alkaline aqueous slurry having the composition as described above is prepared in a slurry making vessel (crutcher). The alkaline aqueous slurry is shear thinning and has a viscosity in the range of from 0.5 to 30 Pas at a temperature of 70° C. and at a shear rate of 50 s⁻¹. The moisture content of the above slurry is 23.1%. Any ingredient added above in liquid form is heated to 70° C., such that the aqueous slurry is never at a temperature below 70° C. Saturated steam at a pressure of 6.0×10⁵ Pa is injected into the crutcher to raise the temperature to 80° C. The slurry is then pumped into a low pressure line (having a pressure of 5.0×10⁵ Pa).

10.26 parts of C₈-C₂₄ alkyl benzene sulphonic acid (HLAS), and 3.2 parts of a 50 w/w % aqueous sodium hydroxide solution are pumped into the low pressure line. The viscosity of the alkaline slurry increases. The resultant mixture is then pumped by a high pressure pump into a high pressure line (having an exit pressure of 8.0×10⁶ Pa). The mixture is then sprayed at a rate of 1,605 kg/hour at a pressure of 8.0×10⁶ Pa and at a temperature of 90° C.+/−2° C. through a spray pressure nozzle into a counter current spray-drying tower with an air inlet temperature of 300° C. The mixture is atomised

Separately, 1.14 parts of ethoxylated C₁₂₋₁₈ alkyl alcohol sulphate anionic detersive surfactant having an average degree of ethoxylation of 1 (AE₁S), 5.7 parts of water and 1 part of sodium carbonate are mixed at 40° C. and sprayed at a rate of 128.5 kg/hr into the tower.

The atomised slurries are dried to produce a solid mixture, which is then cooled and sieved to remove oversize material (>1.8 mm) to form a spray-dried powder, which is free-flowing. Fine material (<0.15 mm) is elutriated with the exhaust the exhaust air in the spray-drying tower and collected in a post tower containment system. The spray-dried powder has a moisture content of about 2.7 wt %, a bulk density of about 480 g/l and a particle size distribution such that greater than 80 wt % of the spray-dried powder has a particle size of from 150 to 710 micrometers. The composition of the spray-dried powder is given below.

### Spray-Dried Laundry Detergent Powder Composition

| Component | % w/w Spray Dried Powder |
|---|---|
| Ethoxylated C₁₂₋₁₈ alkyl alcohol sulphate | 1.5 |
| anionic detersive surfactant having an average | |
| degree of ethoxylation of 1 (AE₁S) | |
| Sodium silicate salt | 10.0 |
| C₈-C₂₄ alkyl benzene sulphonate | 13.6 |
| Acrylate/maleate copolymer | 4.0 |
| Hydroxyethane di(methylene phosphonic acid) | 0.7 |
| Sodium carbonate | 11.9 |
| Sodium sulphate | 53.7 |
| Water | 2.5 |
| Miscellaneous, such as magnesium sulphate, | 2.1 |
| and one or more stabilizers | |
| Total Parts | 100.00 |

### A Granular Laundry Detergent Composition.

| | % w/w granular |
|---|---|
| | laundry detergent |
| Component | composition |
| Spray-dried powder of example 1 (described above) | 59.38 |
| 91.6 wt % active linear alkyl benzene sulphonate | 0.22 |
| flake supplied by Stepan under the tradename | |
| Nacconol 90G ® | |
| Citric acid | 5.00 |
| Sodium percarbonate (having from 12% to | 14.70 |
| 15% active AvOx) | |
| Photobleach particle | 0.01 |
| Lipase (11.00 mg active/g) | 0.70 |
| Amylase (21.55 mg active/g) | 0.33 |
| Protease (56.00 mg active/g) | 0.43 |
| Tetraacetyl ethylene diamine agglomerate | 4.35 |
| (92 wt % active) | |
| Suds suppressor agglomerate (11.5 wt % active) | 0.87 |
| Acrylate/maleate copolymer particle (95.7 wt % active) | 0.29 |
| Green/Blue carbonate speckle | 0.50 |
| Sodium Sulphate | 9.59 |
| Solid perfume particle | 0.63 |
| Ethoxylated C₁₂-C₁₈ alcohol having an average degree | 3.00 |
| of ethoxylation of 7 (AE7) | |
| Total Parts | 100.00 |

The above laundry detergent composition was prepared by dry-mixing all of the above particles (all except the AE7) in a standard batch mixer. The AE7 in liquid form is sprayed on the particles in the standard batch mixer. Alternatively, the AE7 in liquid form is sprayed onto the spray-dried powder of example 1. The resultant powder is then mixed with all of the other particles in a standard batch mixer.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for the production of a spray-dried detergent powder comprising a hexagonal-phase-in-water-forming surfactant the process comprising the steps of:
(i) spraying into a spray-drying tower a detergent slurry free of a hexagonal-phase-in-water-forming surfactant; and
(ii) simultaneously spraying a paste comprising a hexagonal-phase-in-water-forming surfactant,
whereby droplets of the slurry encounter droplets or powder of the hexagonal-phase-in-water-forming surfactant paste so as to form composite granules.

2. A process according to claim 1 wherein the hexagonal-phase-in-water-forming surfactant is a sulphate detersive surfactant.

3. A process according to claim 2 wherein the sulphate detersive surfactant is an alkyl alkoxylated sulphate.

4. A process according to claim 1 wherein the paste comprises from about 60% to about 90% of water by weight thereof.

5. A process according to claim 1 wherein the paste comprises an inorganic salt.

6. A process according to claim 1 wherein the paste comprises an organic salt.

7. A process according to claim 1 wherein the paste comprises a cationic surfactant.

8. A process according to claim 1 claims wherein the paste is sprayed at a temperature of from about 20° C. to about 80° C.

9. A process according to claim 1 wherein the slurry comprises a detersive surfactant selected from anionic surfactant, non-ionic surfactant, cationic surfactant and a mixture thereof.

10. A process according to claim 1 wherein the slurry comprises a sulphonate detersive surfactant.

11. Detergent composition obtainable according to the process of claim 1.

12. A spray-dried granular detergent composition including composite granules comprising:
(i) a core granule comprising one or more anionic and/or nonionic detergent-active compounds that is free of a hexagonal-phase-in-water-forming surfactant, and
(ii) an outer layer, in the form of a coating or of smaller particles, comprising a hexagonal-phase-in-water-forming surfactant.
